(19) United States
(12) Patent Application Publication
(10) Pub. No.: US 2025/0054258 A1
(43) Pub. Date: Feb. 13, 2025

(54) METHOD AND APPARATUS FOR DISPLAYING MAP, DEVICE, STORAGE MEDIUM, AND PRODUCT

(71) Applicant: Tencent Technology (Shenzhen) Company Limited, Shenzhen (CN)

(72) Inventor: Jingwei HE, Shenzhen (CN)

(73) Assignee: Tencent Technology (Shenzhen) Company Limited, Shenzhen (CN)

(21) Appl. No.: 18/925,947

(22) Filed: Oct. 24, 2024

Related U.S. Application Data
(63) Continuation of application No. PCT/CN2023/124183, filed on Oct. 12, 2023.

(30) Foreign Application Priority Data
Nov. 18, 2022 (CN) 202211448432.X

(51) Int. Cl. G06T 19/20; G06T 15/60

(52) U.S. Cl. CPC G06T 19/20; G06T 15/60; G06T 2200/24; G06T 2219/2024

(57) ABSTRACT

This application relates to the field of map technologies, and may be applied to the field of an in-vehicle scene and a map. Three-dimensional geological features included in a to-be-displayed area is determined in response to a display instruction for a to-be-displayed area in an electronic map, the plurality of three-dimensional geological features corresponding to a same shared three-dimensional model. The shared three-dimensional model and display style data of the three-dimensional geological features is obtained. The to-be-displayed area on the electronic map is displayed, and a to-be-displayed three-dimensional geological feature of the plurality of three-dimensional geological features is displayed in the to-be-displayed area based on the shared three-dimensional model and the display style data of the plurality of three-dimensional geological features.

### RELATED APPLICATION

This application is a continuation of International Patent Application No. PCT/CN2023/124183, filed Oct. 12, 2023, which claims priority to Chinese Patent Application No. 202211448432.X, entitled “METHOD AND APPARATUS FOR DISPLAYING MAP, DEVICE, STORAGE MEDIUM, AND PRODUCT” filed with the China National Intellectual Property Administration on Nov. 18, 2022. The contents of International Patent Application No. PCT/CN2023/124183 and Chinese Patent Application No. 202211448432.X are each incorporated herein by reference in their entirety.

### FIELD OF THE TECHNOLOGY

This application relates to the field of map technologies, and in particular, to a map display technology.

### BACKGROUND OF THE DISCLOSURE

An electronic map can support display of a variety of three-dimensional geological features, such as a three-dimensional (3D) architecture block. In the related art, when a building is displayed on the electronic map, the building is generally elongated based on a display outline of the building. For example, the display outline is a cube, the building is elongated into a cuboid with a specific height. The cuboid cannot simulate a real three-dimensional geological feature effect. Consequently, a display effect of the electronic map is reduced.

### SUMMARY

Embodiments of this application provide a method and an apparatus for displaying a map, a device, a storage medium, and a product. This ensures efficiency of displaying a three-dimensional geological feature on an electronic map while a display effect of the electronic map is improved. The technical solutions are as follows.

According to one aspect, a method for displaying a map is provided, performed by a terminal, the method including:
determining, in response to a display instruction for a to-be-displayed area in an electronic map, a plurality of three-dimensional geological features included in the to-be-displayed area, the plurality of three-dimensional geological features corresponding to a same shared three-dimensional model;
obtaining the shared three-dimensional model and display style data of the plurality of three-dimensional geological features, the display style data being configured for indicating a display position, a display angle, and a display size of the three-dimensional geological features in the to-be-displayed area; and
displaying the to-be-displayed area on the electronic map, and displaying a to-be-displayed three-dimensional geological feature of the plurality of three-dimensional geological features in the to-be-displayed area based on the shared three-dimensional model and the display style data of the plurality of three-dimensional geological features.

According to another aspect, an apparatus for displaying a map is provided, the apparatus being deployed on a terminal, the apparatus including:
a determining module, configured to determine, in response to a display instruction for a to-be-displayed area in an electronic map, a plurality of three-dimensional geological features included in the to-be-displayed area, the plurality of three-dimensional geological features corresponding to a same shared three-dimensional model;
an obtaining module, configured to obtain the shared three-dimensional model and display style data of the plurality of three-dimensional geological features, the display style data being configured for indicating a display position, a display angle, and a display size of the three-dimensional geological features in the to-be-displayed area; and
a display module, configured to: display the to-be-displayed area on the electronic map, and display a to-be-displayed three-dimensional geological feature of the plurality of three-dimensional geological features in the to-be-displayed area based on the shared three-dimensional model and the display style data of the plurality of three-dimensional geological features.

According to another aspect, a terminal is provided, the terminal including a processor and a memory, the memory being configured to store at least one segment of computer program, and the at least one segment of computer program being loaded and executed by the processor to implement the method for displaying a map in the embodiments of this application.

According to another aspect, a computer-readable storage medium is provided, the computer-readable storage medium having at least one segment of computer program stored therein, and the at least one segment of computer program being loaded and executed by a processor to implement the method for displaying a map in the embodiments of this application.

According to another aspect, a computer program product is provided, including a computer program, the computer program being stored in a computer-readable storage medium, a processor of a terminal reading the computer program from the computer-readable storage medium, and the processor executing the computer program, to cause the terminal to perform the method for displaying a map according to any one of the foregoing implementations.

The embodiments of this application provide a method for displaying a map. The method determines, in response to a display instruction for a to-be-displayed area of an electronic map, a plurality of three-dimensional geological features corresponding to a same shared three-dimensional model in the to-be-displayed area, and then obtains the shared three-dimensional model and display style data of the plurality of three-dimensional geological features. The shared three-dimensional model can effectively simulate the three-dimensional geological feature, and the display style data may indicate a display position, a display angle, and a display size of the plurality of three-dimensional geological features respectively in the to-be-displayed area. Therefore, to improve a display effect of the three-dimensional geological feature, a to-be-displayed three-dimensional geological feature of the plurality of three-dimensional geological features may be displayed based on the obtained shared three-dimensional model and the display style data of the plurality of three-dimensional geological features. Because the three-dimensional model can effectively simulate the three-dimensional geological feature, and display the three-dimensional geological feature based on a real display position, display angle, and display size of the three-dimensional geological features in the to-be-displayed area, the display effect of the electronic map is improved.

### BRIEF DESCRIPTION OF THE DRAWINGS

To describe the technical solutions in embodiments of this application more clearly, the following briefly describes the accompanying drawings required for describing embodiments. Apparently, the accompanying drawings in the following descriptions merely show some embodiments of this application, and a person of ordinary skill in the art may still derive other drawings based on these accompanying drawings without creative efforts.

FIG. 1 is a schematic diagram of an implementation environment according to an embodiment of this application.

FIG. 2 is a flowchart of a method for displaying a map according to an embodiment of this application.

FIG. 3 is a flowchart of a method for displaying a map according to an embodiment of this application.

FIG. 4 is a schematic diagram of a pyramid model according to an embodiment of this application.

FIG. 5 is a schematic diagram of parsing geological feature information according to an embodiment of this application.

FIG. 6 is a schematic diagram of a field of view distal line according to an embodiment of this application.

FIG. 7 is a schematic diagram of a field of view division line according to an embodiment of this application.

FIG. 8 is a schematic diagram of an electronic map according to an embodiment of this application.

FIG. 9 is a flowchart of another method for displaying a map according to an embodiment of this application.

FIG. 10 is a flowchart of another method for displaying a map according to an embodiment of this application.

FIG. 11 is a flowchart of another method for displaying a map according to an embodiment of this application.

FIG. 12 is a flowchart of displaying a three-dimensional geological feature according to an embodiment of this application.

FIG. 13 is a flowchart of another method for displaying a map according to an embodiment of this application.

FIG. 14 is a flowchart of another method for displaying a map according to an embodiment of this application.

FIG. 15 is a schematic diagram of an electronic map in a snow scene according to an embodiment of this application.

FIG. 16 is a flowchart of another method for displaying a map according to an embodiment of this application.

FIG. 17 is a schematic diagram of an electronic map in a night scene according to an embodiment of this application.

FIG. 18 is a flowchart of another method for displaying a map according to an embodiment of this application.

FIG. 19 is a schematic diagram of an electronic map according to an embodiment of this application.

FIG. 20 is a block diagram of an apparatus for displaying a map according to an embodiment of this application.

FIG. 21 is a block diagram of a terminal according to an embodiment of this application.

### DESCRIPTION OF EMBODIMENTS

To make the objectives, technical solutions, and advantages of this application clearer, the following further describes embodiments of this application in detail with reference to the accompanying drawings.

In this application, terms such as “first” and “second” are used to distinguish between same items or similar items with substantially a same role and function. There is no logical or temporal dependence between “first”, “second”, and “nth”, and a quantity and an execution order are not limited.

In this application, the term “at least one” means one or more, and “a plurality of” means two or more.

All information (including, but not limited to, user equipment information, user personal information, and the like), data (including, but not limited to, data configured for analysis, stored data, displayed data, and the like), and a signal involved in this application are authorized by a user or fully authorized by all parties, and the collection, use, and processing of relevant data need to comply with the related laws, regulations, and standards of related countries and regions. For example, electronic maps involved in this application are all obtained under full authorization.

Terms involved in this application are explained below.

An intelligent traffic system (ITS) is also referred to as an intelligent transportation system, and is a comprehensive transportation system that effectively and comprehensively applies advanced science and technologies (information technology, computer technology, data communication technology, sensor technology, electronic control technology, automatic control theory, operations research, artificial intelligence, and the like) to transportation, service control, and vehicle manufacturing, and enhances a connection between a vehicle, a road, and a user. Therefore, a comprehensive transportation system that ensures safety, improves efficiency, improves an environment, and saves energy is formed.

An intelligent vehicle infrastructure cooperative system (IVICS) is referred to as a vehicle infrastructure cooperative system for short, and is a development direction of the intelligent traffic system. The vehicle infrastructure cooperative system is a safe, efficient, and environmentally friendly road traffic system that adopts advanced wireless communication and new-generation Internet technologies to comprehensively implement dynamic real-time information interaction between vehicles and vehicles and roads, and performs active safety control of vehicles and collaborative road management based on collection and integration of full-time dynamic traffic information, to fully realize effective cooperation between people, vehicles, and roads, ensure traffic safety, and improve traffic efficiency.

The following describes an implementation environment involved in this application.

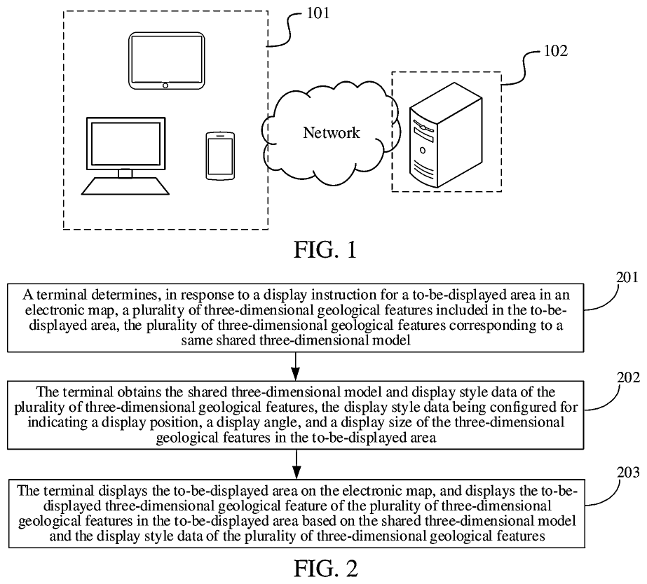

A method for displaying a map provided in the embodiments of this application can be performed by a terminal. The following describes a schematic diagram of an implementation environment of the method for displaying a map according to the embodiments of this application. Referring to FIG. 1, the implementation environment includes a terminal 101 and a server 102. The terminal 101 and the server 102 can be connected directly or indirectly in a wired or wireless communication manner. This is not limited in this application. In some embodiments, an application that displays an electronic map is installed on the terminal 101, and the server 102 is configured to provide a background service for the application. The method for displaying a map provided in the embodiments of this application may be applied to various scenarios, including, but not limited to, cloud technologies, artificial intelligence, intelligent transportation, assistance driving, and the like.

In some embodiments, the terminal 101 may be a smartphone, a tablet computer, a notebook computer, a desktop computer, an intelligent voice interaction device, a smart home appliance, an in-vehicle terminal, an aircraft, or the like, but is not limited thereto. In some embodiments, the server 102 is an independent server, or can be a server cluster or a distributed system including a plurality of physical servers, or can alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform. In some embodiments, the server 102 undertakes primary computing work, and the terminal 101 undertakes secondary computing work; or the server 102 undertakes secondary computing work, and the terminal 101 undertakes primary computing work; or a distributed computing architecture is used between the server 102 and the terminal 101 to perform collaborative computing.

FIG. 2 is a flowchart of a method for displaying a map according to an embodiment of this application. Referring to FIG. 2, in this embodiment of this application, the method is performed by a terminal as an example. The method includes the following operations.

201: The terminal determines, in response to a display instruction for a to-be-displayed area in an electronic map, a plurality of three-dimensional geological features included in the to-be-displayed area, the plurality of three-dimensional geological features corresponding to a same shared three-dimensional model.

In this embodiment of this application, the three-dimensional geological feature corresponding to the same shared three-dimensional model may be a building, a tree, a mountain, a river, or the like. For example, if all the plurality of three-dimensional geological features are trees, the shared three-dimensional model is a three-dimensional tree model. In addition, the plurality of three-dimensional geological features may be further classified. For example, if the plurality of three-dimensional geological features are pines in the trees, the shared three-dimensional model is a three-dimensional pine model.

202: The terminal obtains the shared three-dimensional model and display style data of the plurality of three-dimensional geological features, the display style data being configured for indicating a display position, a display angle, and a display size of the three-dimensional geological features in the to-be-displayed area.

In this embodiment of this application, different three-dimensional geological features in the plurality of three-dimensional geological features have different display positions in the to-be-displayed area. To be specific, different three-dimensional geological features are distributed at different positions in the to-be-displayed area, and display angles and display sizes of the different three-dimensional geological features in the to-be-displayed area may be the same or different.

203: The terminal displays the to-be-displayed area on the electronic map, and displays a to-be-displayed three-dimensional geological feature of the plurality of three-dimensional geological features in the to-be-displayed area based on the shared three-dimensional model and the display style data of the plurality of three-dimensional geological features.

The to-be-displayed three-dimensional geological feature is a three-dimensional geological feature that needs to be displayed in the plurality of three-dimensional geological features. In this embodiment of this application, the to-be-displayed three-dimensional geological feature may be all of the plurality of three-dimensional geological features, or may be a part of the plurality of three-dimensional geological features.

When the to-be-displayed three-dimensional geological feature is the part of the plurality of three-dimensional geological features, the terminal may first select a part of the three-dimensional geological features from the plurality of three-dimensional geological features to the part of the three-dimensional geological features determined as the to-be-displayed three-dimensional geological feature, obtain display style data of the to-be-displayed three-dimensional geological feature from the display style data of the plurality of three-dimensional geological features, and display the to-be-displayed three-dimensional geological feature in the to-be-displayed area based on the shared three-dimensional model and the selected display style data of the to-be-displayed three-dimensional geological feature.

In this embodiment of this application, the part of the plurality of three-dimensional geological features are displayed, so that displaying all of the plurality of three-dimensional geological features is avoided while the plurality of three-dimensional geological features is displayed in a same batch, and efficiency of displaying the three-dimensional geological feature on the electronic map is improved.

This embodiment of this application provides the method for displaying a map. The method determines, in response to the display instruction for the to-be-displayed area of the electronic map, the plurality of three-dimensional geological features corresponding to the same shared three-dimensional model in the to-be-displayed area, and then obtains the shared three-dimensional model and the display style data of the plurality of three-dimensional geological features. The shared three-dimensional model can effectively simulate the three-dimensional geological feature, and the display style data may indicate the display position, the display angle, and the display size of the plurality of three-dimensional geological features respectively in the to-be-displayed area. Therefore, to improve a display effect of the three-dimensional geological feature, the to-be-displayed three-dimensional geological feature of the plurality of three-dimensional geological features may be displayed based on the obtained shared three-dimensional model and the display style data of the plurality of three-dimensional geological features. Because the three-dimensional model can effectively simulate the three-dimensional geological feature, and display the three-dimensional geological feature based on a real display position, display angle, and display size of the three-dimensional geological features in the to-be-displayed area, the display effect of the electronic map is improved.

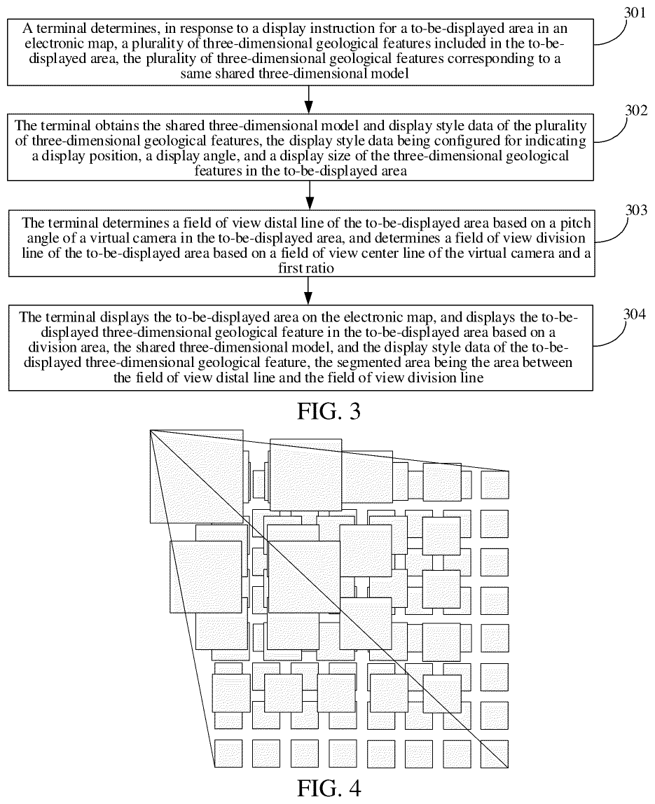

FIG. 2 shows a process for displaying the map. The following further describes a process for displaying the map based on FIG. 3. The following mainly uses an example in which the to-be-displayed three-dimensional geological feature is the part of the plurality of three-dimensional geological features for description. FIG. 3 is a flowchart of a method for displaying a map according to an embodiment of this application. Referring to FIG. 3, in this embodiment of this application, that the method is performed by a terminal is used as an example for description. The method includes the following operations.

301: The terminal determines, in response to a display instruction for a to-be-displayed area in an electronic map, a plurality of three-dimensional geological features included in the to-be-displayed area, the plurality of three-dimensional geological features corresponding to a same shared three-dimensional model.

In some embodiments, the electronic map is a navigation map. Correspondingly, a triggering manner of the display instruction includes the following several manners.

A first manner is that the terminal obtains a travel position of a vehicle, and triggers the display instruction in response to that the travel position changes. In this embodiment of this application, a change of the travel position is a change caused by the vehicle traveling to the to-be-displayed area. Based on this manner, the display instruction is triggered, so that a navigation interface can be updated in time, and a display effect of the navigation interface is improved.

A second manner is that the terminal triggers the display instruction in response to a search instruction for the to-be-displayed area. In this embodiment of this application, the search instruction may be an instruction triggered based on a search box, or may be an instruction triggered in response to a scale operation or a tap operation for the to-be-displayed area. Based on this manner, the display instruction is triggered, so that a display interface of the electronic map can be updated in time, and search efficiency is improved.

In this embodiment of this application, the three-dimensional geological features included in the to-be-displayed area may correspond to the same three-dimensional model or different three-dimensional models. In the process for displaying the map, the plurality of three-dimensional geological features corresponding to the same shared three-dimensional model in the to-be-displayed area may be determined. Correspondingly, the foregoing process of determining the plurality of three-dimensional geological features corresponding to the same shared three-dimensional model included in the to-be-displayed area includes the following operations: clustering the plurality of three-dimensional geological features when the to-be-displayed area includes the plurality of three-dimensional geological features, and determining the plurality of three-dimensional geological features corresponding to the same shared three-dimensional model.

In this embodiment of this application, the terminal clusters the plurality of three-dimensional geological features, to obtain a plurality of categories, and the three-dimensional geological features included in each category correspond to the same shared three-dimensional model. For example, the plurality of categories may include an architecture block category, a tree category, a gas station category, a convenience store category, and the like. Correspondingly, the shared three-dimensional models corresponding to the three-dimensional geological features included in each category are a three-dimensional architecture block model, a three-dimensional tree model, a three-dimensional gas station model, and a three-dimensional convenience store model respectively. In some embodiments, each category may be further classified. For example, the tree category may be further classified into categories such as a pine category, a banyan category, and a poplar category. Correspondingly, the shared three-dimensional models corresponding to the three-dimensional geological features included in the categories are a three-dimensional pine model, a three-dimensional banyan model, and a three-dimensional poplar model respectively.

In a possible implementation, the terminal clusters the plurality of three-dimensional geological features based on model identifiers respectively corresponding to the plurality of three-dimensional geological features, the model identifier being configured for indicating a three-dimensional model corresponding to the three-dimensional geological feature. The model identifier is obtained based on a map tile corresponding to the to-be-displayed area. Correspondingly, a process of obtaining the model identifier includes the following operations: The terminal obtains a plurality of map tiles corresponding to the to-be-displayed area, the plurality of map tiles including geological feature information of the plurality of three-dimensional geological features in the to-be-displayed area. The terminal parses the geological feature information included in the plurality of map tiles, to obtain the model identifiers and display style information of the plurality of three-dimensional geological features, the display style information including display position information, display angle information, and display size information of the three-dimensional geological feature in the to-be-displayed area. The geological feature information is binary data-encoded information. After parsing the geological feature information, the terminal obtains the model identifier and the display style information.

In this embodiment of this application, each map tile includes geological feature information of a three-dimensional geological feature in one sub-area in the to-be-displayed area. After determining the to-be-displayed area through a virtual camera, the terminal crops the to-be-displayed area, to generate a plurality of tile identifiers (ID), the tile identifier being configured for indicating the map tile. The terminal downloads the map tile from a server based on a uniform resource locator (URL) corresponding to the tile identifier. A cropping process is to match an area range of the to-be-displayed area with an area range corresponding to each map tile in a tile set, determine a map tile having an intersection with the area range as a map tile corresponding to the to-be-displayed area, and then obtain the tile identifier of the map tile.

After downloading the map tile of any area from the server, the terminal saves the downloaded map tile in cache. When obtaining the map tile based on the tile identifier next time, the terminal may first load the map tile from the cache. Only when no map tile corresponding to the tile identifier exists in the cache, the terminal downloads the map tile from the server. In this way, a plurality of downloads of the map tile are avoided, and efficiency of obtaining the map tile can be improved.

In this embodiment of this application, the map tile exists in a pyramid model. The plurality of map tiles are arranged in levels, rows, and columns. A unique tile identifier is assigned to each map tile in the pyramid model. The tile identifier may be represented as x-y-z, where x represents a column of the map tile, y represents a row of the map tile, and z represents a level of the map tile. In this embodiment of this application, the same electronic map may correspond to a plurality of size levels. Different size levels correspond to different levels of map tiles. Resolutions of pictures generated by the map tiles at different levels are different. The resolution refers to an actual distance represented by a pixel on a screen. Referring to FIG. 4, FIG. 4 is a schematic diagram of a pyramid model according to an embodiment of this application.

In this embodiment of this application, if the plurality of categories are obtained through clustering, operation 302 to operation 304 are performed respectively for each category including the plurality of three-dimensional geological features, to display the three-dimensional geological features of the plurality of categories on the electronic map.

302: The terminal obtains the shared three-dimensional model and display style data of the plurality of three-dimensional geological features, the display style data being configured for indicating a display position, a display angle, and a display size of the three-dimensional geological features in the to-be-displayed area.

In this embodiment of this application, a process in which the terminal obtains the shared three-dimensional model and the display style data of the plurality of three-dimensional geological features includes operation (1) and operation (2).

Operation (1). The terminal obtains, based on the model identifier of the shared three-dimensional model, target model information corresponding to the model identifier from a style manager, and parses the target model information, to obtain the shared three-dimensional model. The style manager has a plurality of model identifiers and model information respectively corresponding to the plurality of model identifiers stored therein, and the model identifier is obtained based on the map tile corresponding to the to-be-displayed area.

In this embodiment of this application, the shared three-dimensional model includes mesh data and texture data, and the target model information includes mesh information and texture information. The terminal parses the mesh information, to obtain the mesh data, and the terminal parses the texture information, to obtain the texture data. The mesh data is configured for generating a three-dimensional shape of the three-dimensional geological feature, and the texture data is configured for generating a texture of the three-dimensional geological feature.

In this embodiment of this application, a data type of the mesh information is a common three-dimensional data type, such as an OBJ (that is, a three-dimensional file format), a FeedBack exterminator (FBX, that is, a three-dimensional file format), or a 3D studio scene (3DS, that is, a three-dimensional file format). A texture format of the texture data is a common texture format, such as a joint photographic experts group (JPEG, that is, an image file format), a bitmap (BMP), or a portable network graphic (PNG). The terminal parses the mesh information and the texture information, that is, performs format conversion on the mesh information and the texture information, to obtain the mesh data and the texture data that can be configured for generating the three-dimensional geological feature. In some embodiments, if displaying the three-dimensional geological feature on the electronic map is implemented based on a graphics processing unit (GPU), formats of the mesh data and the texture data are formats supporting rendering by the GPU.

In this embodiment of this application, a process of obtaining the style manager includes the following operations: The terminal obtains a model list from the server, the model list including a plurality of three-dimensional models corresponding to the electronic map. The terminal writes the plurality of three-dimensional models in the model list and model identifiers respectively corresponding to the plurality of three-dimensional models into the style manager. In this way, the three-dimensional models are stored on a terminal side, so that efficiency of obtaining the three-dimensional models can be improved subsequently.

Operation (2) The terminal performs matrix transformation on the display position information, the display angle information, and the display size information respectively based on a position transformation matrix corresponding to a coordinate system of the electronic map, to obtain a display position matrix, a display angle matrix, and a display size matrix, and uses a product of the display position matrix, the display angle matrix, and the display size matrix as the display style data, the display position information, the display angle information, and the display size information being obtained based on the map tile corresponding to the to-be-displayed area.

In this embodiment of this application, the position transformation matrix includes a translation matrix, a rotation matrix, and a scale matrix, and is configured to perform matrix transformation on the display position information, the display angle information, and the display size information respectively, to obtain the display position matrix, the display angle matrix, and the display size matrix.

In this embodiment of this application, the display position information, the display angle information, and the display size information are information determined based on the map tile. The display position information is a position offset relative to a preset position on the map tile, the display angle information is an angle offset relative to a preset direction on the map tile, and the display size information is a size offset relative to a preset size of the map tile. Therefore, matrix transformation needs to be performed on the electronic map based on the position transformation matrix corresponding to the coordinate system of the electronic map. Correspondingly, the translation matrix is constructed based on the preset position information, and then matrix transformation is performed on the display position based on the translation matrix, to obtain the display position matrix. The rotation matrix is constructed based on the preset direction, and then matrix transformation is performed on the display angle information based on the rotation matrix, to obtain the display angle matrix. The scale matrix is constructed based on the preset size, and then matrix transformation is performed on the display size information based on the scale matrix, to obtain the display size matrix.

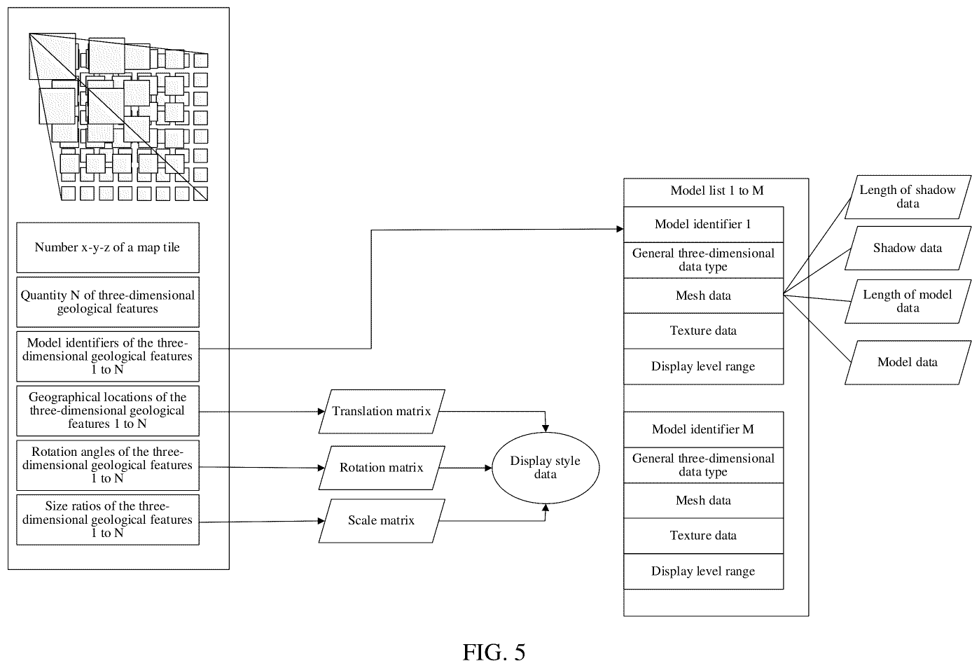

Referring to FIG. 5, FIG. 5 is a schematic diagram of parsing geological feature information according to an embodiment of this application. A number of a map tile corresponding to the geological feature information, that is, the tile identifier, is x-y-x, and a quantity of three-dimensional geological features corresponding to the map tile is N. Each of the three-dimensional geological features 1 to N corresponds to a model identifier, a geographic position, a rotation angle, and a size ratio. N is an integer greater than 0. Corresponding target model information may be found in the style manager based on the model identifier. A quantity of model information stored in the style manager is M, and M is an integer greater than 0. The model information includes mesh information and texture information, and also includes a general three-dimensional data type of the mesh information and a display level range of the three-dimensional model. The display level range is configured for indicating a size level of the electronic map to which the three-dimensional model is applicable. The mesh information is binary data-encoded information, includes shadow data and model data, and further includes length information of the shadow data and length information of the model data, which facilitates parsing the mesh information based on the length information.

303: The terminal determines a field of view distal line of the to-be-displayed area based on a pitch angle of the virtual camera in the to-be-displayed area, and determines a field of view division line of the to-be-displayed area based on a field of view center line of the virtual camera and a first ratio.

In this embodiment of this application, the field of view center line is located directly below the virtual camera in the to-be-displayed area, the field of view distal line is a boundary line of a front area overlooked by the virtual camera, a field of view near-end line is a boundary line of a rear area overlooked by the virtual camera, and the field of view division line is located between the field of view center line and the field of view distal line, and is configured for determining an area with low pixel accuracy of the three-dimensional geological feature.

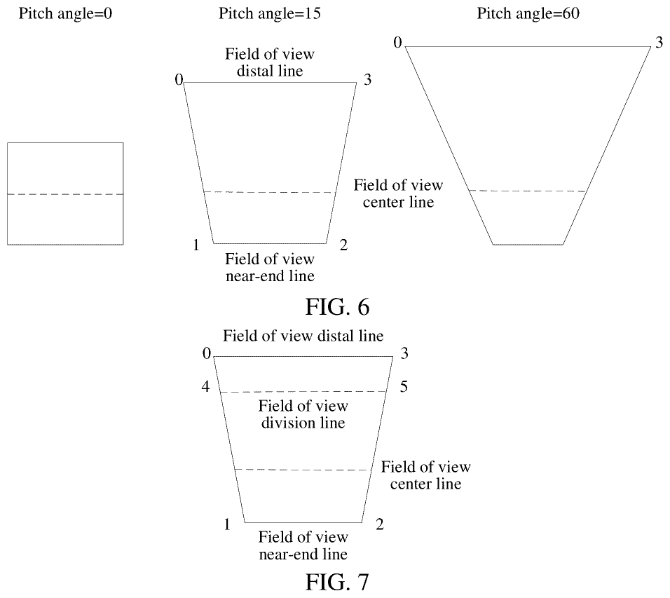

At a same size level of the electronic map, the field of view center line is unchanged, and shapes of the field of view corresponding to different pitch angles are different, so that the field of view distal lines are different. Referring to FIG. 6, FIG. 6 is a schematic diagram of a field of view distal line according to an embodiment of this application. It can be seen from the figure that different pitch angles correspond to different field of view distal lines, and positions and lengths of the field of view distal lines corresponding to the different pitch angles are different. A length of the field of view center line is not less than a length of the field of view near-end line and not greater than the length of the field of view distal line.

In this embodiment of this application, a first ratio is a ratio of a length of a field of view division line to the length of the field of view center line. The first ratio may be set and changed as needed. Therefore, a manner in which the terminal determines the field of view division line of the to-be-displayed area based on the field of view center line of the virtual camera and the first ratio may be that the terminal uses a product of the length of the field of view center line and the first ratio as the length of the field of view division line, and then determines the field of view division line in the to-be-displayed area based on the length of the field of view division line. The length of the field of view division line is not less than the length of the field of view center line. That is, the first ratio is not less than 1. Referring to FIG. 7, FIG. 7 is a schematic diagram of a field of view division line according to an embodiment of this application. In FIG. 7, the segment “4-5” corresponds to the field of view division line, the segment “0-3” corresponds to the field of view distal line, the segment “1-2” corresponds to the field of view near-end line, and an area between the field of view distal line and the field of view division line is a segmented area.

304: The terminal displays the to-be-displayed area on the electronic map, and displays the to-be-displayed three-dimensional geological feature in the to-be-displayed area based on a segmented area, the shared three-dimensional model, and the display style data of the to-be-displayed three-dimensional geological feature, the segmented area being the area between the field of view distal line and the field of view division line.

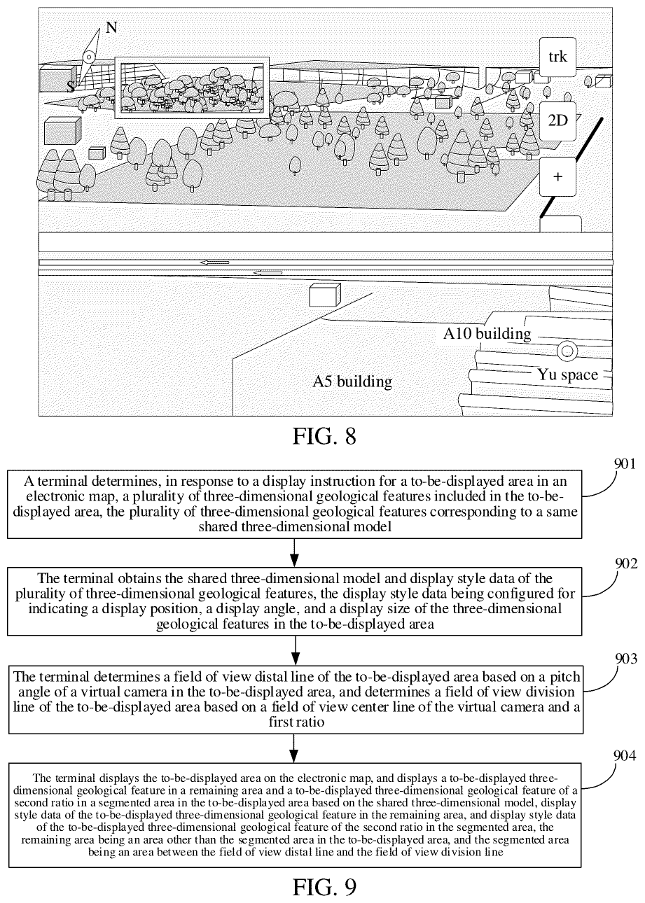

In this embodiment of this application, a process of displaying the to-be-displayed three-dimensional geological feature of the plurality of three-dimensional geological features in the to-be-displayed area based on the segmented area, the shared three-dimensional model, and the display style data of the plurality of three-dimensional geological features is implemented through operation 304. The segmented area is an area close to the skyline. A large quantity of three-dimensional geological features exists in the area because of a viewing angle. The three-dimensional geological features in the segmented area have low importance and low pixels. Completely drawing the three-dimensional geological features in the segmented area has low contribution to a display effect of the electronic map, and consumes more resources. Referring to FIG. 8, FIG. 8 is a schematic diagram of an electronic map according to an embodiment of this application. The electronic map includes a large quantity of three-dimensional geological features close to the skyline. Therefore, in this embodiment of this application, in a process of displaying the to-be-displayed three-dimensional geological feature of the plurality of three-dimensional geological features, an impact of the segmented area is considered, to improve the display effect and display efficiency.

Based on a characteristic of the three-dimensional geological feature in the segmented area, in a process of displaying the to-be-displayed three-dimensional geological feature of the plurality of three-dimensional geological features, removing the three-dimensional geological feature in the segmented area is mainly considered. Therefore, in a possible implementation, a manner of displaying the to-be-displayed three-dimensional geological feature based on the segmented area, the shared three-dimensional model, and the display style data of the to-be-displayed three-dimensional geological feature may be to display a to-be-displayed three-dimensional geological feature in a remaining area based on the shared three-dimensional model and display style data of the to-be-displayed three-dimensional geological feature in the remaining area, where the remaining area is an area other than the segmented area in the to-be-displayed area, and the segmented area is an area between the field of view distal line and the field of view division line.

In this embodiment of this application, the to-be-displayed three-dimensional geological feature is a plurality of three-dimensional geological features in the remaining area. Correspondingly, a process in which the terminal determines the display style data of the plurality of three-dimensional geological features in the remaining area includes the following operations: The terminal determines the three-dimensional geological feature in the segmented area, and removes the display style data of the three-dimensional geological feature in the segmented area from the display style data of the plurality of three-dimensional geological features, to obtain the display style data of the plurality of three-dimensional geological features in the remaining area.

In this embodiment of this application, the three-dimensional geological feature in the segmented area is removed, and it is unnecessary to display the three-dimensional geological feature in the segmented area. This ensures the display effect while efficiency of displaying the three-dimensional geological feature on the electronic map is improved.

In this embodiment of this application, displaying the three-dimensional geological feature on the electronic map is implemented through the GPU of the terminal. Correspondingly, the terminal uploads the three-dimensional models in the style manager to the GPU once. The terminal generates a style array based on the display style data of the to-be-displayed three-dimensional geological feature, uploads the style array to the GPU, and renders, through the GPU, the plurality of three-dimensional geological features in the to-be-displayed area in the same batch based on the shared three-dimensional model and the style array. In other words, the to-be-displayed three-dimensional geological feature may be displayed in the to-be-displayed area in one batch.

When the plurality of categories of three-dimensional geological features exist in the to-be-displayed area, for each category, based on the display style data of the to-be-displayed three-dimensional geological feature included in the category, a style array corresponding to the category is generated, and the style arrays respectively corresponding to the plurality of categories are all uploaded to the GPU, so that all the three-dimensional geological features of the plurality of categories are displayed in the to-be-displayed area through the GPU. In this embodiment of this application, the GPU may invoke an open graphics library (OpenGL) interface to display the three-dimensional geological feature.

In some embodiments, displaying the three-dimensional geological feature on the electronic map may be implemented by superimposing a plurality of 3D layers. The plurality of 3D layers may be respectively configured for displaying different categories of the three-dimensional geological features. Correspondingly, the plurality of 3D layers may correspond to different map tiles. In this case, the terminal needs to obtain map tiles respectively corresponding to the plurality of 3D layers from the server, so that the server may simultaneously input a plurality of URLs and a plurality of sets of three-dimensional models to the terminal. Each set of three-dimensional model corresponds to one 3D layer, and includes a plurality of three-dimensional models to be configured for the three-dimensional geological feature in the 3D layer. In this way, various categories of three-dimensional geological features such as a gas station, a convenience store, and a tree, may be superimposed on the electronic map, and a merchant-customized 3D image Internet Protocol (IP) may be superimposed on the electronic map.

This embodiment of this application provides the method for displaying a map. The method determines the plurality of three-dimensional geological features corresponding to the same shared three-dimensional model in the to-be-displayed area, and then displays the to-be-displayed three-dimensional geological feature of the plurality of three-dimensional geological features based on the obtained shared three-dimensional model and the display style data of the plurality of three-dimensional geological features. In this way, displaying all three-dimensional geological features is avoided while the plurality of three-dimensional geological features are displayed in the same batch. However, because the three-dimensional model can effectively simulate the three-dimensional geological feature, the efficiency of displaying the three-dimensional geological feature on the electronic map is ensured, and the display effect of the electronic map is improved.

FIG. 3 shows an implementation of displaying the to-be-displayed three-dimensional geological feature. The following describes another implementation of displaying a to-be-displayed three-dimensional geological feature based on FIG. 9. FIG. 9 is a flowchart of a method for displaying a map according to an embodiment of this application. Referring to FIG. 9, in this embodiment of this application, the method is performed by a terminal as an example. The method includes the following operations.

901: The terminal determines, in response to a display instruction for a to-be-displayed area in an electronic map, a plurality of three-dimensional geological features included in the to-be-displayed area, the plurality of three-dimensional geological features corresponding to a same shared three-dimensional model.

902: The terminal obtains the shared three-dimensional model and display style data of the plurality of three-dimensional geological features, the display style data being configured for indicating a display position, a display angle, and a display size of the three-dimensional geological features in the to-be-displayed area.

903: The terminal determines a field of view distal line of the to-be-displayed area based on a pitch angle of a virtual camera in the to-be-displayed area, and determines a field of view division line of the to-be-displayed area based on a field of view center line of the virtual camera and a first ratio.

In this embodiment of this application, operation 901 to operation 903 are the same as operation 301 to operation 303. Details are not described herein again.

904: The terminal displays the to-be-displayed area on the electronic map, and displays a to-be-displayed three-dimensional geological feature in a remaining area and a to-be-displayed three-dimensional geological feature of a second ratio in a segmented area in the to-be-displayed area based on the shared three-dimensional model, display style data of the to-be-displayed three-dimensional geological feature in the remaining area, and display style data of the to-be-displayed three-dimensional geological feature of the second ratio in the segmented area, the remaining area being an area other than the segmented area in the to-be-displayed area, and the segmented area being an area between the field of view distal line and the field of view division line.

In this embodiment of this application, the terminal may select the to-be-displayed three-dimensional geological feature of the second ratio from the segmented area for display. The to-be-displayed three-dimensional geological feature of the second ratio is a three-dimensional geological feature that needs to be retained in the segmented area. There may be a plurality of manners in which the terminal may select the to-be-displayed three-dimensional geological feature of the second ratio from the segmented area. In a possible implementation, the terminal may randomly select the to-be-displayed three-dimensional geological feature of the second ratio from the to-be-displayed three-dimensional geological feature in the segmented area, so that selection efficiency is improved. In another possible implementation, the terminal may select the to-be-displayed three-dimensional geological feature of the second ratio based on a distance between the to-be-displayed three-dimensional geological feature in the segmented area, so that the to-be-displayed three-dimensional geological feature of the second ratio is evenly distributed in the segmented area. This method improves the selection of the three-dimensional geological feature of the second ratio, and can further improve a display effect of the segmented area.

In some embodiments, the terminal removes the display style data of the three-dimensional geological feature in the segmented area other than the to-be-displayed three-dimensional geological feature of the second ratio from the display style data of the plurality of three-dimensional geological features. That is, the terminal obtains display style data of the to-be-displayed three-dimensional geological feature in the remaining area and display style data of the to-be-displayed three-dimensional geological feature of the second ratio in the segmented area.

In this embodiment of this application, a process of displaying the to-be-displayed three-dimensional geological feature of the plurality of three-dimensional geological features in the to-be-displayed area based on the segmented area, the shared three-dimensional model, and the display style data of the plurality of three-dimensional geological features is implemented through operation 904. In other words, operation 904 is another implementation of displaying the to-be-displayed three-dimensional geological feature of the plurality of three-dimensional geological features based on the segmented area, the shared three-dimensional model, and the display style data of the plurality of three-dimensional geological features. This operation of displaying the three-dimensional geological feature is the same as the implementation of displaying the three-dimensional geological feature on the electronic map based on the GPU in operation 304. Accordingly, details of this operation are not described herein again.

The three-dimensional geological feature in the segmented area has a low contribution to a display effect of the electronic map. However, in this embodiment of this application, only the to-be-displayed three-dimensional geological feature of the second ratio in the segmented area is displayed, the three-dimensional geological feature in the segmented area is simplified, and it is unnecessary to display all the three-dimensional geological feature in the segmented area, so that this ensures the display effect while the efficiency of displaying the three-dimensional geological feature on the electronic map is improved.

This embodiment of this application provides the method for displaying a map. The method determines the plurality of three-dimensional geological features corresponding to the same shared three-dimensional model in the to-be-displayed area, and then displays the to-be-displayed three-dimensional geological feature of the plurality of three-dimensional geological features based on the obtained shared three-dimensional model and the display style data of the plurality of three-dimensional geological features. In this way, displaying all three-dimensional geological features is avoided while the plurality of three-dimensional geological features are displayed in the same batch. However, because the three-dimensional model can effectively simulate the three-dimensional geological feature, the efficiency of displaying the three-dimensional geological feature on the electronic map is ensured, and the display effect of the electronic map is improved.

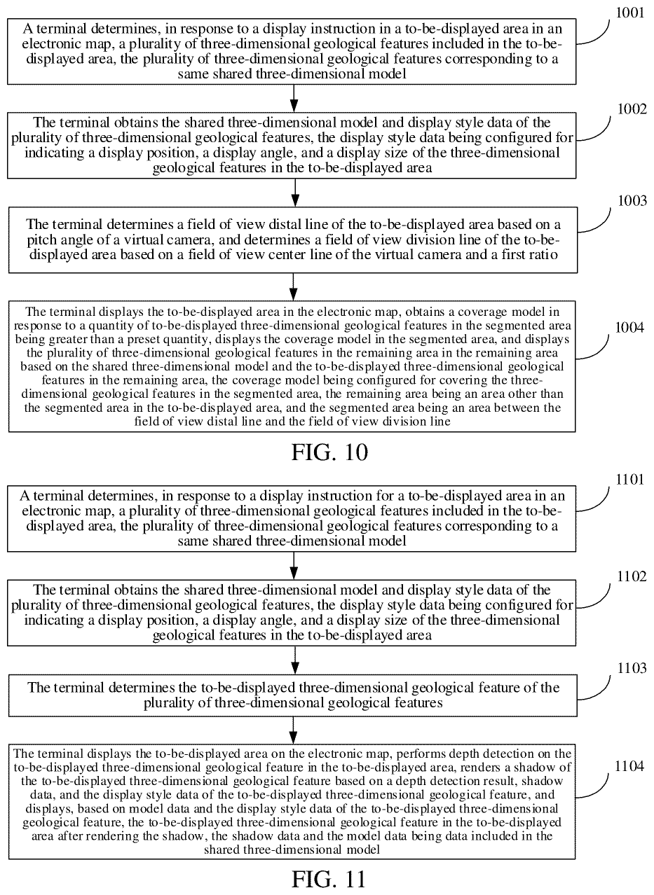

FIG. 9 shows an implementation of displaying the to-be-displayed three-dimensional geological feature. The following describes another implementation of displaying a to-be-displayed three-dimensional geological feature based on FIG. 10. FIG. 10 is a flowchart of a method for displaying a map according to an embodiment of this application. Referring to FIG. 10, in this embodiment of this application, the method is performed by a terminal as an example. The method includes the following operations.

1001: The terminal determines, in response to a display instruction for a to-be-displayed area in an electronic map, a plurality of three-dimensional geological features included in the to-be-displayed area, the plurality of three-dimensional geological features corresponding to a same shared three-dimensional model.

1002: The terminal obtains the shared three-dimensional model and display style data of the plurality of three-dimensional geological features, the display style data being configured for indicating a display position, a display angle, and a display size of the three-dimensional geological features in the to-be-displayed area.

1003: The terminal determines a field of view distal line of the to-be-displayed area based on a pitch angle of a virtual camera, and determines a field of view division line of the to-be-displayed area based on a field of view center line of the virtual camera and a first ratio.

In this embodiment of this application, operation 1001 to operation 1003 are the same as operation 301 to operation 303. Details are not described herein again.

1004: The terminal displays the to-be-displayed area on the electronic map, obtains a coverage model in response to a quantity of to-be-displayed three-dimensional geological features in the segmented area being greater than a preset quantity, displays the coverage model in the segmented area, and displays the plurality of three-dimensional geological features in the remaining area in the remaining area based on the shared three-dimensional model and the to-be-displayed three-dimensional geological feature in the remaining area, the coverage model being configured for covering the three-dimensional geological feature in the segmented area, the remaining area being an area other than the segmented area in the to-be-displayed area, and the segmented area being an area between the field of view distal line and the field of view division line.

In this embodiment of this application, the preset quantity may be set and changed as needed.

In this embodiment of this application, the coverage model may be a general model. That is, any segmented area may use the model. For example, the coverage model may be formed based on a plurality of three-dimensional geological features with fixed display style data. In this way, ubiquity of the coverage model is improved, which improves display efficiency. The coverage model may alternatively be a model corresponding to the shared three-dimensional model, and a texture of the coverage model is the same as a texture of the shared three-dimensional model. Correspondingly, the style manager may further store coverage models corresponding to a plurality of three-dimensional models. In this way, specificity of the coverage model is improved, which improves the display effect.

In this embodiment of this application, the preset quantity may be set and changed as needed. The terminal may display, in the segmented area, all to-be-displayed three-dimensional geological features in the segmented area, or may display, in the segmented area, a second ratio of the to-be-displayed three-dimensional geological feature in the segmented area in response to that a quantity of the three-dimensional geological features in the segmented area is not greater than a preset quantity.

In this embodiment of this application, a process of displaying the to-be-displayed three-dimensional geological feature of the plurality of three-dimensional geological features in the to-be-displayed area based on the segmented area, the shared three-dimensional model, and the display style data of the plurality of three-dimensional geological features is implemented through operation 1004. This operation of displaying the three-dimensional geological feature is the same as the implementation of displaying the three-dimensional geological feature on the electronic map based on the GPU in operation 304. Details of this operation are not described herein again.

The three-dimensional geological feature in the segmented area has a low contribution to a display effect of the electronic map. However, in this embodiment of this application, because the coverage model covers the three-dimensional geological feature in the segmented area, and the segmented area is displayed based on the coverage model, it is unnecessary to display the three-dimensional geological feature in the segmented area respectively. This ensures a display effect while efficiency of displaying the three-dimensional geological feature on the electronic map is improved.

The embodiments of this application provide the method for displaying a map. The method determines the plurality of three-dimensional geological features corresponding to the same shared three-dimensional model in the to-be-displayed area, and then displays the to-be-displayed three-dimensional geological feature of the plurality of three-dimensional geological features based on the obtained shared three-dimensional model and the display style data of the plurality of three-dimensional geological features. In this way, displaying of all three-dimensional geological features is avoided while the plurality of three-dimensional geological features are displayed in the same batch. However, because the three-dimensional model can effectively simulate the three-dimensional geological feature, the efficiency of displaying the three-dimensional geological feature on the electronic map is ensured, and the display effect of the electronic map is improved.

FIG. 10 shows an implementation of displaying the to-be-displayed three-dimensional geological feature. The following describes an implementation of displaying a three-dimensional geological feature based on shadow and based on FIG. 11. FIG. 11 is a flowchart of a method for displaying a map according to an embodiment of this application. Referring to FIG. 11, in this embodiment of this application, the method is performed by a terminal as an example. The method includes the following operations.

1101: The terminal determines, in response to a display instruction for a to-be-displayed area in an electronic map, a plurality of three-dimensional geological features included in the to-be-displayed area, the plurality of three-dimensional geological features corresponding to a same shared three-dimensional model.

1102: The terminal obtains the shared three-dimensional model and display style data of the plurality of three-dimensional geological features, the display style data being configured for indicating a display position, a display angle, and a display size of the three-dimensional geological features in the to-be-displayed area.

In this embodiment of this application, operation 1101 to operation 1102 are the same as operation 301 to operation 302. Details are not described herein again.

1103: The terminal determines the to-be-displayed three-dimensional geological feature of the plurality of three-dimensional geological features.

In this embodiment of this application, the terminal may determine the to-be-displayed three-dimensional geological feature of the plurality of three-dimensional geological features based on operation 304, operation 904, or operation 1004. In a possible implementation, the to-be-displayed three-dimensional geological feature may be a part of the plurality of three-dimensional geological features. For example, the to-be-displayed three-dimensional geological feature may be only the three-dimensional geological feature in a remaining area, or may be the three-dimensional geological feature in a remaining area and the three-dimensional geological feature in a segmented area of a second ratio.

1104: The terminal displays the to-be-displayed area on the electronic map, performs depth detection on the to-be-displayed three-dimensional geological feature in the to-be-displayed area, renders a shadow of the to-be-displayed three-dimensional geological feature based on a depth detection result, shadow data, and the display style data of the to-be-displayed three-dimensional geological feature, and displays, based on model data and the display style data of the to-be-displayed three-dimensional geological feature, the to-be-displayed three-dimensional geological feature in the to-be-displayed area after rendering the shadow, where the shadow data and the model data are data included in the shared three-dimensional model.

In this embodiment of this application, the depth detection result is configured for indicating a depth of the three-dimensional geological feature relative to a virtual camera, that is, a distance between the three-dimensional geological feature and the virtual camera. A three-dimensional geological feature with a large depth is blocked by a three-dimensional geological feature with a small depth. For example, if a depth of a three-dimensional geological feature A is less than a depth of a three-dimensional geological feature B, the three-dimensional geological feature B is blocked by the three-dimensional geological feature A. In other words, the three-dimensional geological feature A is visually displayed in front of the three-dimensional geological feature B.

Correspondingly, the foregoing process of rendering the shadow of the to-be-displayed three-dimensional geological feature based on the depth detection result, shadow data, and display style data of the to-be-displayed three-dimensional geological feature includes: The terminal determines a block state of the three-dimensional geological feature based on the depth detection result, the block state being configured for indicating an area that is blocked in the shadow of the three-dimensional geological feature. The area may be all or some of the area of the shadow. The terminal displays an area that is not blocked in the shadow of the three-dimensional geological feature based on this block state, the shadow data, and the display style data. The terminal updates the shadow data and the display style data based on the block state, and displays, based on the updated shadow data and the display style data, the area that is not blocked in the shadow of the three-dimensional geological feature. The updated shadow data and the updated display style data only include data of the area that is not blocked in the shadow.

In this embodiment of this application, when rendering the shadow, the terminal turns off a depth writing switch. When displaying the three-dimensional geological feature in the to-be-displayed area after rendering the shadow, the terminal turns on the depth writing switch, and superimposes the three-dimensional model on the shadow, to implement a shadow effect of the three-dimensional geological feature. This operation of displaying the three-dimensional geological feature is the same as the implementation of displaying the three-dimensional geological feature on the electronic map based on the GPU in operation 304. As such, details of this operation are not described herein again.

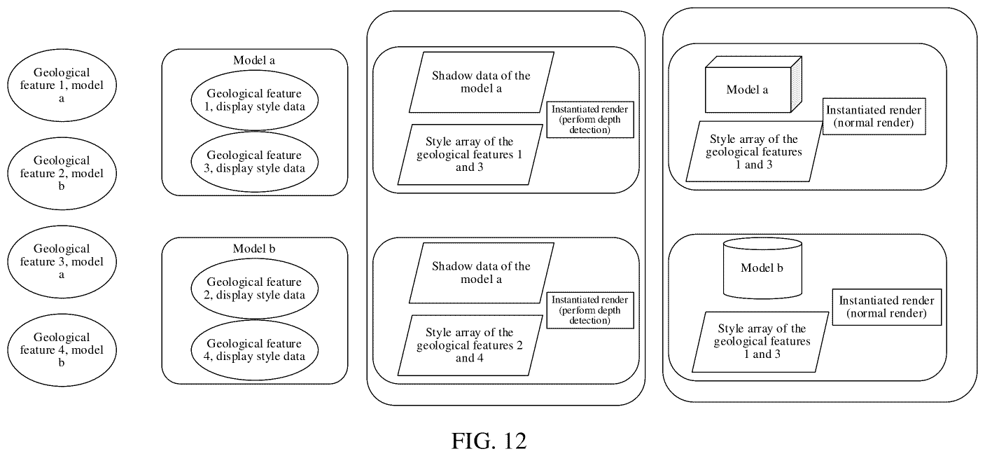

Referring to FIG. 12, FIG. 12 is a flowchart of displaying a three-dimensional geological feature according to an embodiment of this application. A terminal first determines a plurality of three-dimensional geological features corresponding to a same shared three-dimensional model, then performs depth detection, and renders a shadow of the to-be-displayed three-dimensional geological feature based on a depth detection result, shadow data, and display style data of the to-be-displayed three-dimensional geological feature. Then, the terminal displays, based on the model data and the display style data of the to-be-displayed three-dimensional geological feature, the to-be-displayed three-dimensional geological feature in the to-be-displayed area after rendering the shadow.

In this embodiment of this application, a process of displaying the to-be-displayed three-dimensional geological feature of the plurality of three-dimensional geological features in the to-be-displayed area based on the shared three-dimensional model and the display style data of the plurality of three-dimensional geological features is implemented based on operation 1104. In this embodiment, the three-dimensional geological feature is displayed based on the shadow, so that the three-dimensional geological feature can have a more realistic display effect. Further, a shadow is first rendered based on the depth detection result, and then the three-dimensional model is superimposed on the shadow, to avoid a depth conflict, and to further improve a display effect of the electronic map.

The embodiments of this application provide the method for displaying a map. The method determines the plurality of three-dimensional geological features corresponding to the same shared three-dimensional model in the to-be-displayed area, and then displays the to-be-displayed three-dimensional geological feature of the plurality of three-dimensional geological features based on the obtained shared three-dimensional model and the display style data of the plurality of three-dimensional geological features. In this way, displaying all three-dimensional geological features is avoided while the plurality of three-dimensional geological features are displayed in the same batch. However, because the three-dimensional model can effectively simulate the three-dimensional geological feature, the efficiency of displaying the three-dimensional geological feature on the electronic map is ensured, and the display effect of the electronic map is improved.

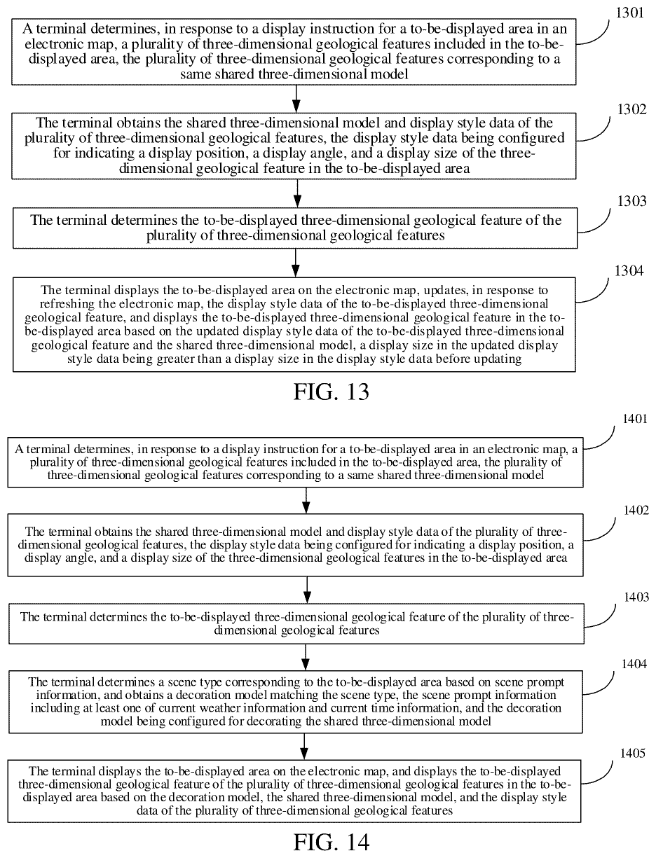

FIG. 11 shows an implementation of displaying the three-dimensional geological feature based on the shadow. The following describes an implementation of dynamically displaying a three-dimensional geological feature based on FIG. 13. FIG. 13 is a flowchart of a method for displaying a map according to an embodiment of this application. Referring to FIG. 13, in this embodiment of this application, the method is performed by a terminal as an example. The method includes the following operations.

1301: The terminal determines, in response to a display instruction for a to-be-displayed area in an electronic map, a plurality of three-dimensional geological features included in the to-be-displayed area, the plurality of three-dimensional geological features corresponding to a same shared three-dimensional model.

1302: The terminal obtains the shared three-dimensional model and display style data of the plurality of three-dimensional geological features, the display style data being configured for indicating a display position, a display angle, and a display size of the three-dimensional geological features in the to-be-displayed area.

1303: The terminal determines the to-be-displayed three-dimensional geological feature of the plurality of three-dimensional geological features.

In this embodiment of this application, operation 1301 to operation 1303 are the same as operation 1101 to operation 1103. As such, details of these operations are not described herein again.

In some embodiments, the electronic map is periodically refreshed, and the display size of the to-be-displayed three-dimensional geological feature is positively correlated with interface display time of the electronic map. In this way, the three-dimensional geological feature is dynamically generated, and a display effect is improved. Correspondingly, a process of displaying the to-be-displayed three-dimensional geological feature of the plurality of three-dimensional geological features in the to-be-displayed area based on the shared three-dimensional model and the display style data of the plurality of three-dimensional geological features is implemented through operation 1304.

1304: The terminal displays the to-be-displayed area on the electronic map, updates, in response to refreshing the electronic map, the display style data of the to-be-displayed three-dimensional geological feature, and displays the to-be-displayed three-dimensional geological feature in the to-be-displayed area based on the updated display style data of the to-be-displayed three-dimensional geological feature and the shared three-dimensional model, where a display size in the updated display style data is greater than a display size in the display style data before updating.

When the display size of the three-dimensional geological features reaches a target size, the display style data is not updated any more. The target size is a size matching a size level of a current electronic map.

In this embodiment of this application, the display size of the three-dimensional geological features is updated in response to refreshing the electronic map, so that the three-dimensional geological feature with different display sizes can be displayed on the electronic map in different frames, and the three-dimensional geological feature on the electronic map is dynamically generated. Therefore, a display effect of the electronic map is improved. For example, when the three-dimensional geological feature is a tree, display sizes of the tree on a plurality of frames of the electronic map may be sizes corresponding to the tree at different growth stages.

In this embodiment of this application, the operation of displaying the three-dimensional geological feature is the same as the implementation of displaying the three-dimensional geological feature on the electronic map based on the GPU in operation 304. As such, details of this operation are not described herein again.

The embodiments of this application provide the method for displaying a map. The method determines the plurality of three-dimensional geological features corresponding to the same shared three-dimensional model in the to-be-displayed area, and then displays the to-be-displayed three-dimensional geological feature of the plurality of three-dimensional geological features based on the obtained shared three-dimensional model and the display style data of the plurality of three-dimensional geological features. In this way, displaying all three-dimensional geological features is avoided while the plurality of three-dimensional geological features are displayed in the same batch. However, because the three-dimensional model can effectively simulate the three-dimensional geological feature, the efficiency of displaying the three-dimensional geological feature on the electronic map is ensured, and the display effect of the electronic map is improved.

FIG. 13 shows an implementation of dynamically displaying the three-dimensional geological feature. The following describes an implementation of displaying a three-dimensional geological feature based on a scene type and based on FIG. 14. FIG. 14 is a flowchart of a method for displaying a map according to an embodiment of this application. Referring to FIG. 14, in this embodiment of this application, the method is performed by a terminal as an example. The method includes the following operations.

1401: The terminal determines, in response to a display instruction for a to-be-displayed area in an electronic map, a plurality of three-dimensional geological features included in the to-be-displayed area, the plurality of three-dimensional geological features corresponding to a same shared three-dimensional model.

1402: The terminal obtains the shared three-dimensional model and display style data of the plurality of three-dimensional geological features, the display style data being configured for indicating a display position, a display angle, and a display size of the three-dimensional geological features in the to-be-displayed area.

1403: The terminal determines the to-be-displayed three-dimensional geological feature of the plurality of three-dimensional geological features.

In this embodiment of this application, operation 1401 to operation 1403 are the same as operation 1101 to operation 1103. As such, details of these operations are not described herein again.

1404: The terminal determines a scene type corresponding to the to-be-displayed area based on scene prompt information, and obtains a decoration model matching the scene type, the scene prompt information including at least one of current weather information and current time information, and the decoration model being configured for decorating the shared three-dimensional model.

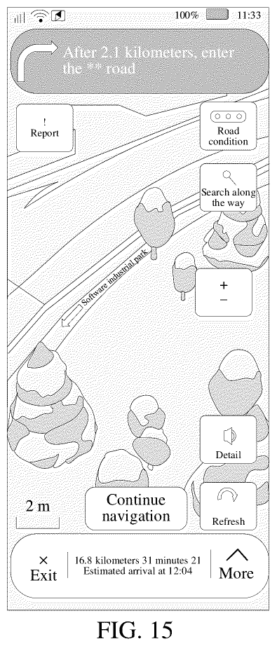

In this embodiment of this application, the current weather information includes various types of weather information such as snowing, raining, and haze, and the current time information includes various types of time information such as daytime, night time, morning time, and evening time. When the current weather information indicates snowing weather, it is determined that the scene type is a snow scene. When the current time information indicates the night time, it is determined that the scene type is a night scene. When the current weather information indicates the snowing weather and the current time information indicates the night time, it is determined that the scene type is a night snow scene. The decoration model matching the snow scene may be a snow layer model to be covered on the three-dimensional geological feature. Referring to FIG. 15, FIG. 15 is an electronic map in a snow scene according to an embodiment of this application.

1405: The terminal displays the to-be-displayed area on the electronic map, and displays the to-be-displayed three-dimensional geological feature of the plurality of three-dimensional geological features in the to-be-displayed area based on the decoration model, the shared three-dimensional model, and the display style data of the plurality of three-dimensional geological features.

In this embodiment of this application, the operation of displaying the three-dimensional geological feature is the same as the implementation of displaying the three-dimensional geological feature on the electronic map based on the GPU in operation 304. As such, details of this operation are not described herein again.

In this embodiment of this application, a process of displaying the to-be-displayed three-dimensional geological feature of the plurality of three-dimensional geological features in the to-be-displayed area based on the shared three-dimensional model and the display style data of the plurality of three-dimensional geological features is implemented through operation 1404 and operation 1405. In this embodiment of this application, the decoration model is obtained based on the scene type, and the three-dimensional geological feature is displayed based on the decoration model, so that the displayed three-dimensional geological feature matches the current scene, and a display effect of the electronic map is further improved.

The embodiments of this application provide the method for displaying a map. The method determines the plurality of three-dimensional geological features corresponding to the same shared three-dimensional model in the to-be-displayed area, and then displays the to-be-displayed three-dimensional geological feature of the plurality of three-dimensional geological features based on the obtained shared three-dimensional model and the display style data of the plurality of three-dimensional geological features. In this way, displaying all three-dimensional geological features is avoided while the plurality of three-dimensional geological features are displayed in the same batch. However, because the three-dimensional model can effectively simulate the three-dimensional geological feature, the efficiency of displaying the three-dimensional geological feature on the electronic map is ensured, and the display effect of the electronic map is improved.

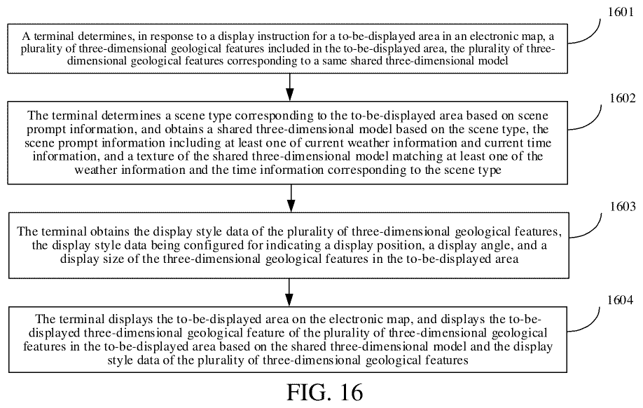

FIG. 14 shows an implementation of displaying the three-dimensional geological feature based on the scene type. The following describes another implementation of displaying a three-dimensional geological feature based on a scene type and based on FIG. 16. FIG. 16 is a flowchart of a method for displaying a map according to an embodiment of this application. Referring to FIG. 16, in this embodiment of this application, the method is performed by a terminal as an example. The method includes the following operations.

1601: The terminal determines, in response to a display instruction for a to-be-displayed area in an electronic map, a plurality of three-dimensional geological features included in the to-be-displayed area, the plurality of three-dimensional geological features corresponding to a same shared three-dimensional model.

In this embodiment of this application, operation 1601 is the same as operation 301. As such, details of this operation are not described herein again.

1602: The terminal determines a scene type corresponding to the to-be-displayed area based on scene prompt information, and obtains a shared three-dimensional model based on the scene type, the scene prompt information including at least one of current weather information and current time information, and a texture of the shared three-dimensional model matching at least one of the weather information and the time information corresponding to the scene type.

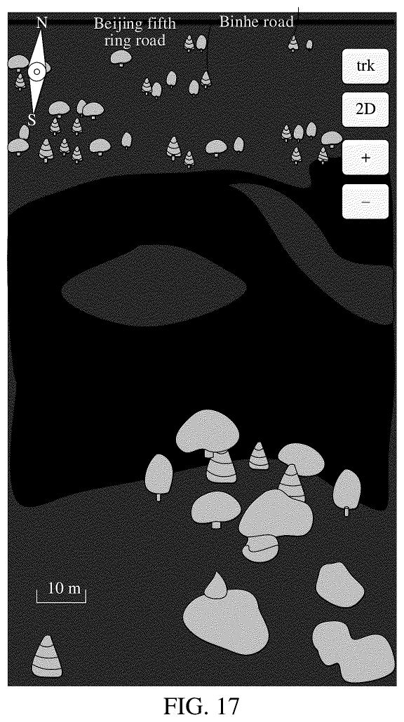

In some embodiments, a same model identifier may correspond to a plurality of three-dimensional models. The plurality of three-dimensional models correspond to a same three-dimensional geological feature and different scene types. Therefore, a shared three-dimensional model matching the scene type may be obtained based on the model identifier and the scene type. The three-dimensional models corresponding to different scene types have a same three-dimensional shape and different textures. For example, when the current time information indicates night time, it is determined that the scene type is a night scene. In this case, the texture of the shared three-dimensional model is a black texture corresponding to the night time. For example, trees in a night scene are black, and trees in a snow scene may be white and green. Referring to FIG. 17, FIG. 17 is a schematic diagram of an electronic map in a night scene according to an embodiment of this application.

In some embodiments, the shared three-dimensional model is obtained based on the scene type, and mesh data of the shared three-dimensional model matches at least one of the weather information and the time information corresponding to the scene type. For example, a height and a width of a tree in the snow scene are a first preset height and a first preset width respectively, and a height and a width of a tree in a non-snow scene are a second preset height and a second preset width respectively. The first preset height is greater than the second preset height, and the first preset width is greater than the second preset width. For another example, in a windy scene, a tree has an oblique angle. To be specific, the mesh data corresponding to the tree is configured for generating an oblique three-dimensional tree model.

In this embodiment of this application, the shared three-dimensional model is obtained through operation 1602. In this way, the shared three-dimensional model is obtained based on the scene type, so that the shared three-dimensional model matches the current scene, and the display effect of the electronic map is further improved.

1603: The terminal obtains the display style data of the plurality of three-dimensional geological features, the display style data being configured for indicating a display position, a display angle, and a display size of the three-dimensional geological features in the to-be-displayed area.

In this embodiment of this application, operation 1603 is the same as the process of obtaining the display style data in operation 302. As such, details of this operation are not described herein again.

1604: The terminal displays the to-be-displayed area on the electronic map, and displays the to-be-displayed three-dimensional geological feature of the plurality of three-dimensional geological features in the to-be-displayed area based on the shared three-dimensional model and the display style data of the plurality of three-dimensional geological features.

In this embodiment of this application, operation 1604 is the same as the implementation of operation 303 and operation 304, operation 903 and operation 904, operation 1003 and operation 1004, operation 1103 and operation 1104, or operation 1403 and operation 1404. As such, details of these operations are not described herein again.

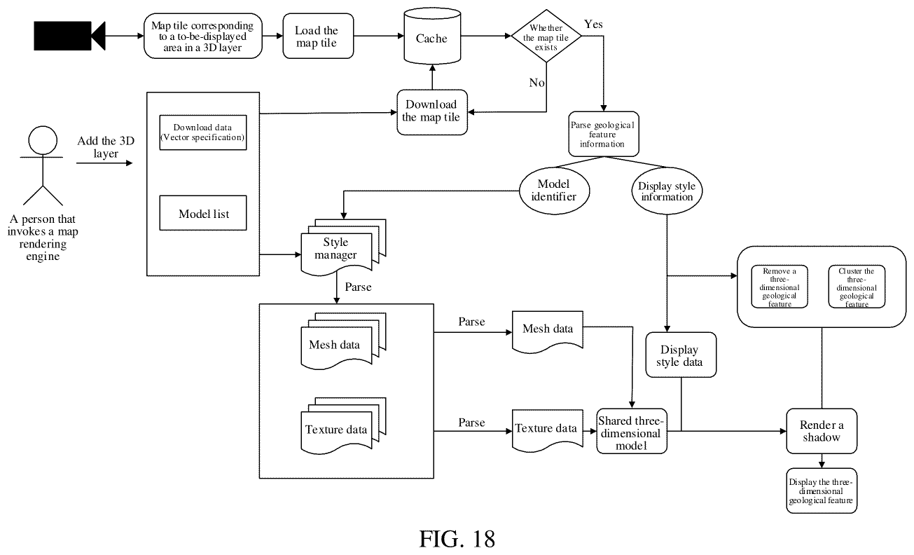

Referring to FIG. 18, FIG. 18 is a flowchart of a method for displaying a map according to an embodiment of this application. A person that invokes a map rendering engine may add a 3D layer to an electronic map. A map tile and a model list needed for the 3D layer are stored on a server. The map tile stores data in vector specifications. After obtaining the model list from the server, a terminal writes the model list into a style manager. The terminal determines a tile identifier of a map tile corresponding to a to-be-displayed area in response to a display instruction for the to-be-displayed area, and then loads the map tile from cache. When the map tile does not exist in the cache, the map tile needs to be downloaded from the server. When the map tile exists in the cache, geological feature information included in the map tile is parsed to obtain a model identifier and display style information. Mesh information and texture information are obtained from the style manager based on the model identifier, and the mesh information and the texture information are parsed respectively to obtain mesh data and texture data, to obtain a shared three-dimensional model. Display style data is obtained based on the display style information, and a segmented area is also determined, to remove a three-dimensional geological feature and cluster the three-dimensional geological feature. Then, shadow and the three-dimensional geological feature are sequentially rendered based on the shared three-dimensional model and the display style data, to display the to-be-displayed three-dimensional geological feature on the electronic map.

In some embodiments, when a quantity of three-dimensional geological features included in the to-be-displayed area is less than a preset quantity, that is, an area with a small range and a low density may match an individual bounding box of each three-dimensional geological feature with the to-be-displayed area, to calculate, in real time, the to-be-displayed three-dimensional geological feature in the to-be-displayed area.

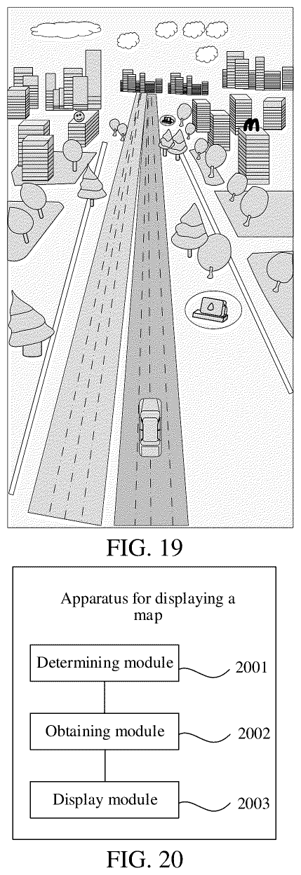

According to the method for displaying a map provided in this embodiment of this application, a large range of general three-dimensional geological features may be superimposed and displayed on the electronic map. A display location and a display format of the three-dimensional geological feature can be dynamically configured, and various three-dimensional geological feature layers may be superimposed and displayed, the to-be-displayed three-dimensional geological feature is displayed, the three-dimensional geological feature is displayed in batches, the three-dimensional geological feature is dynamically displayed, and the three-dimensional geological feature is displayed dynamically or based on the shadow. In this way, richer display content is provided for the electronic map, and display fluency and display efficiency of the electronic map are improved. According to the method provided in this embodiment of this application, the three-dimensional geological feature can be smoothly and realistically displayed on the electronic map under different business requirements such as driving, retrieving, and browsing. Referring to FIG. 19, FIG. 19 is a schematic diagram of an electronic map according to an embodiment of this application. A plurality of three-dimensional geological features are displayed on the electronic map.

The embodiments of this application provide the method for displaying a map. The method determines the plurality of three-dimensional geological features corresponding to the same shared three-dimensional model in the to-be-displayed area, and then displays the to-be-displayed three-dimensional geological feature of the plurality of three-dimensional geological features based on the obtained shared three-dimensional model and the display style data of the plurality of three-dimensional geological features. In this way, displaying all three-dimensional geological features is avoided while the plurality of three-dimensional geological features are displayed in the same batch. However, because the three-dimensional model can effectively simulate the three-dimensional geological feature, the efficiency of displaying the three-dimensional geological feature on the electronic map is ensured, and the display effect of the electronic map is improved.

FIG. 20 is a block diagram of an apparatus for displaying a map according to an embodiment of this application. The apparatus is configured to perform operations when the foregoing method for displaying a map is performed. Referring to FIG. 20, the apparatus includes:

a determining module 2001, configured to determine, in response to a display instruction for a to-be-displayed area in an electronic map, a plurality of three-dimensional geological features included in the to-be-displayed area, the plurality of three-dimensional geological features corresponding to a same shared three-dimensional model;

an obtaining module 2002, configured to obtain the shared three-dimensional model and display style data of the plurality of three-dimensional geological features, the display style data being configured for indicating a display position, a display angle, and a display size of the three-dimensional geological features in the to-be-displayed area; and

a display module 2003, configured to: display the to-be-displayed area on the electronic map, and display a to-be-displayed three-dimensional geological feature of the plurality of three-dimensional geological features in the to-be-displayed area based on the shared three-dimensional model and the display style data of the plurality of three-dimensional geological features.

In some embodiments, the display module 2003 is configured to: determine a part of the plurality of three-dimensional geological features as the to-be-displayed three-dimensional geological feature, and obtain display style data of the to-be-displayed three-dimensional geological feature from the display style data of the plurality of three-dimensional geological features; and

display the to-be-displayed three-dimensional geological feature based on the shared three-dimensional model and the display style data of the to-be-displayed three-dimensional geological feature.

In some embodiments, the display module 2003 is configured to: determine a field of view distal line of the to-be-displayed area based on a pitch angle of a virtual camera in the to-be-displayed area; determine a field of view division line of the to-be-displayed area based on a field of view center line of the virtual camera and a first ratio, the first ratio being a ratio of a length of the field of view division line to a length of the field of view center line; and display the to-be-displayed three-dimensional geological feature in the to-be-displayed area based on a segmented area, the shared three-dimensional model, and the display style data of the plurality of three-dimensional geological features, the segmented area being determined based on the field of view distal line and the field of view division line.

In some embodiments, the display module 2003 is configured to: display a to-be-displayed three-dimensional geological feature in a remaining area in the to-be-displayed area based on the shared three-dimensional model and display style data of the to-be-displayed three-dimensional geological feature in the remaining area, the remaining area being an area other than the segmented area in the to-be-displayed area; or display a to-be-displayed three-dimensional geological feature in a remaining area and a to-be-displayed three-dimensional geological feature of a second ratio in the segmented area in the to-be-displayed area based on the shared three-dimensional model, display style data of the to-be-displayed three-dimensional geological feature in the remaining area, and display style data of the to-be-displayed three-dimensional geological feature of the second ratio in the segmented area.

In some embodiments, the display module 2003 is configured to: obtain a coverage model in response to a quantity of to-be-displayed three-dimensional geological features in the segmented area being greater than a preset quantity, the coverage model being configured for covering the to-be-displayed three-dimensional geological feature in the segmented area; display the coverage model in the segmented area, and display, in the remaining area, the to-be-displayed three-dimensional geological feature in the remaining area based on the shared three-dimensional model and display style data of the to-be-displayed three-dimensional geological feature in the remaining area, the remaining area being a region other than the segmented area in the to-be-displayed area.

In some embodiments, the determining module 2001 is configured to: cluster, if a plurality of three-dimensional geological features included in the to-be-displayed area exist, the three-dimensional geological features included in the to-be-displayed area, and determine the plurality of three-dimensional geological features corresponding to the same shared three-dimensional model.

In some embodiments, the shared three-dimensional model includes shadow data and model data, the shadow data is configured for generating a shadow of the three-dimensional geological feature, and the model data is configured for generating a three-dimensional model of the three-dimensional geological feature. The display module 2003 is configured to: perform depth detection on the to-be-displayed three-dimensional geological feature in the to-be-displayed area, render a shadow of the to-be-displayed three-dimensional geological feature based on a depth detection result, shadow data, and display style data of the to-be-displayed three-dimensional geological feature; and display, based on the model data and the display style data of the to-be-displayed three-dimensional geological feature, the to-be-displayed three-dimensional geological feature in the to-be-displayed area after rendering the shadow.

In some embodiments, the electronic map is periodically refreshed, and the display size of the to-be-displayed three-dimensional geological feature is positively correlated with interface display time of the electronic map.

In some embodiments, the display module 2003 is configured to: update display style data of a to-be-displayed three-dimensional geological feature in response to refreshing the electronic map, a display size in the updated display style data being greater than a display size in the display style data before the updating; and display the to-be-displayed three-dimensional geological feature based on the updated display style data of the to-be-displayed three-dimensional geological feature and the shared three-dimensional model in the to-be-displayed area.

In some embodiments, the display module 2003 is configured to: determine a scene type corresponding to the to-be-displayed area based on scene prompt information, the scene prompt information including at least one of current weather information and current time information; obtain a decoration model matching the scene type, the decoration model being configured for decorating the shared three-dimensional model; and display the to-be-displayed three-dimensional geological feature of the plurality of three-dimensional geological features in the to-be-displayed area based on the decoration model, the shared three-dimensional model, and the display style data of the plurality of three-dimensional geological features.

In some embodiments, the obtaining module 2002 is configured to: determine a scene type corresponding to the to-be-displayed area based on scene prompt information, the scene prompt information including at least one of current weather information and current time information; and obtain the shared three-dimensional model based on the scene type, a texture of the shared three-dimensional model matching at least one of weather information and time information corresponding to the scene type.

In some embodiments, the obtaining module 2002 is configured to: obtain, based on a model identifier of the shared three-dimensional model, target model information corresponding to the model identifier from a style manager, and parsing the target model information, to obtain the shared three-dimensional model, the style manager having a plurality of model identifiers and model information respectively corresponding to the plurality of model identifiers stored therein, and the model identifier being obtained based on a map tile corresponding to the to-be-displayed area; and perform matrix transformation on display position information, display angle information, and display size information respectively based on a position transformation matrix corresponding to a coordinate system of the electronic map, to obtain a display position matrix, a display angle matrix, and a display size matrix, and using a product of the display position matrix, the display angle matrix, and the display size matrix as the display style data, the display position information, the display angle information, and the display size information being obtained based on the map tile corresponding to the to-be-displayed area.

The embodiments of this application provide the apparatus for displaying a map. The apparatus determines, in response to a display instruction for the to-be-displayed area of the electronic map, the plurality of three-dimensional geological features corresponding to the same shared three-dimensional model in the to-be-displayed area, and then obtains the shared three-dimensional model and the display style data of the plurality of three-dimensional geological features. The shared three-dimensional model can effectively simulate the three-dimensional geological feature, and the display style data may indicate the display position, the display angle, and the display size of the plurality of three-dimensional geological features respectively in the to-be-displayed area. Therefore, to improve a display effect of the three-dimensional geological feature, the to-be-displayed three-dimensional geological feature of the plurality of three-dimensional geological features may be displayed based on the obtained shared three-dimensional model and the display style data of the plurality of three-dimensional geological features. Because the three-dimensional model can effectively simulate the three-dimensional geological feature, and display the three-dimensional geological feature based on a real display position, display angle, and display size of the three-dimensional geological features in the to-be-displayed area, the display effect of the electronic map is improved.

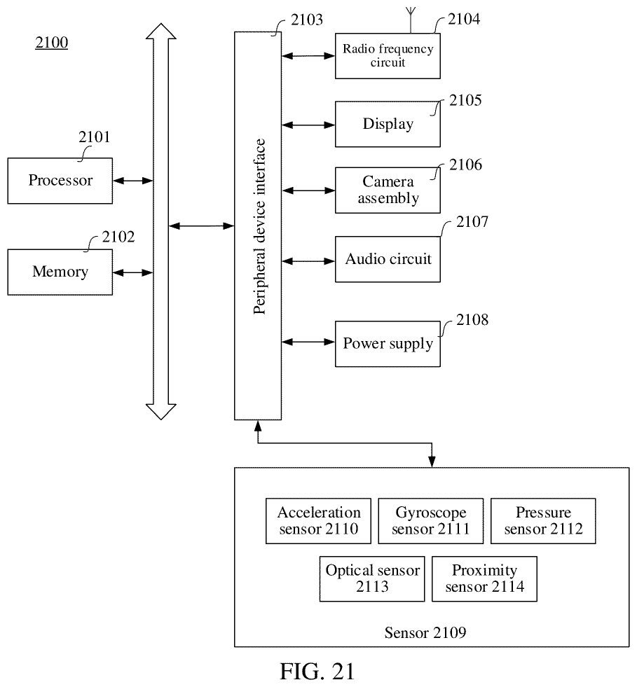

FIG. 21 is a block diagram of a structure of a terminal 2100 according to an exemplary embodiment of this application. The terminal 2100 may be a portable mobile terminal, for example, a smartphone, a tablet computer, a moving picture experts group audio layer III (MP3) player, a moving picture experts group audio layer IV (MP4) player, a notebook computer, or a desktop computer. The terminal 2100 may also be referred to as another name such as user equipment, a portable terminal, a laptop terminal, or a desktop terminal.

Generally, the terminal 2100 includes a processor 2101 and a memory 2102.

The processor 2101 may include one or more processing cores, such as a 4-core processor and an 8-core processor. The processor 2101 may be implemented in at least one hardware form of a digital signal processor (DSP), a field-programmable gate array (FPGA), and a programmable logic array (PLA). The processor 2101 may also include a main processor and a co-processor. The main processor is a processor configured to process data in an awake state, and is also referred to as a central processing unit (CPU). The co-processor is a low power consumption processor configured to process the data in a standby state. In some embodiments, the processor 2101 may be integrated with a GPU. The GPU is configured to render and draw content that needs to be displayed on a display. In some embodiments, the processor 2101 may further include an artificial intelligence (AI) processor. The AI processor is configured to process a computing operation related to machine learning.

The memory 2102 may include one or more computer-readable storage media. The computer-readable storage medium may be non-transient. The memory 2102 may also include a high-speed random access memory, a nonvolatile memory, such as one or more disk storage devices and flash storage devices. In some embodiments, the non-transitory computer-readable storage medium in the memory 2102 is configured to store at least one program code, and the at least one program code is configured to be executed by the processor 2101 to implement the method for displaying a map provided in the method embodiments of this application.

In some embodiments, the terminal 2100 further exemplarily includes a peripheral device interface 2103 and at least one peripheral device. The processor 2101, the memory 2102, and the peripheral device interface 2103 may be connected through a bus or a signal cable. Each peripheral device may be connected to the peripheral device interface 2103 through the bus, the signal cable, or a circuit board. Specifically, the peripheral device includes at least one of a radio frequency circuit 2104, a display 2105, a camera assembly 2106, an audio circuit 2107, and a power supply 2108.

In some embodiments, the terminal 2100 further includes one or more sensors 2109. The one or more sensors 2109 include, but are not limited to, an acceleration sensor 2110, a gyroscope sensor 2111, a pressure sensor 2112, an optical sensor 2113, and a proximity sensor 2114.

A person skilled in the art may understand that the structure shown in FIG. 21 does not constitute a limitation on the terminal 2100, and the terminal may include more or fewer components than those shown in the figure, or combine some components, or have different component deployment.

Embodiments of this application further provide a computer-readable storage medium, having at least one computer program stored therein, and the at least one computer program being loaded and executed by a processor to implement the method for displaying a map according to any one of the foregoing implementations.

Embodiments of this application further provide a computer program product, including a computer program, the computer program being stored in a computer-readable storage medium, a processor of a terminal reading the computer program from the computer-readable storage medium, and the processor executing the computer program, to cause the terminal to perform the method for displaying a map according to any one of the foregoing implementations.

In some embodiments, the computer program product in the embodiments of this application may be deployed to be executed on one terminal, or executed on a plurality of terminals located at one location, or executed on a plurality of terminals distributed at a plurality of locations and interconnected by a communication network. The plurality of terminals distributed at a plurality of locations and interconnected by a communication network may form a blockchain system.

The above mentioned descriptions are merely the exemplary embodiments of this application, but are not intended to limit this application. Any modification, equivalent replacement, or improvement made without departing from the spirit and principle of this application need to fall within the protection scope of this application.

What is claimed is:

1. A method for displaying a map, performed by a terminal, the method comprising:
determining, in response to a display instruction for a to-be-displayed area in an electronic map, a plurality of three-dimensional geological features comprised in the to-be-displayed area, the plurality of three-dimensional geological features corresponding to a same shared three-dimensional model;
obtaining the same shared three-dimensional model and display style data of the plurality of three-dimensional geological features, the display style data configured to indicate a display position, a display angle, and a display size of the three-dimensional geological features in the to-be-displayed area; and
displaying the to-be-displayed area on the electronic map, and displaying a to-be-displayed three-dimensional geological feature of the plurality of three-dimensional geological features in the to-be-displayed area based on the same shared three-dimensional model and the display style data of the plurality of three-dimensional geological features.

2. The method according to claim 1, wherein the displaying the to-be-displayed three-dimensional geological feature of the plurality of three-dimensional geological features based on the same shared three-dimensional model and the display style data of the plurality of three-dimensional geological features comprises:
determining a part of the plurality of three-dimensional geological features as the to-be-displayed three-dimensional geological feature, and obtaining display style data of the to-be-displayed three-dimensional geological feature from the display style data of the plurality of three-dimensional geological features; and
displaying the to-be-displayed three-dimensional geological feature based on the same shared three-dimensional model and the display style data of the to-be-displayed three-dimensional geological feature.

3. The method according to claim 2, wherein the displaying the to-be-displayed three-dimensional geological feature based on the same shared three-dimensional model and the display style data of the to-be-displayed three-dimensional geological feature comprises:
determining a field of view distal line of the to-be-displayed area based on a pitch angle of a virtual camera in the to-be-displayed area;
determining a field of view division line of the to-be-displayed area based on a field of view center line of the virtual camera and a first ratio, the first ratio being a ratio of a length of the field of view division line to a length of the field of view center line; and
displaying the to-be-displayed three-dimensional geological feature in the to-be-displayed area based on a segmented area, the same shared three-dimensional model, and the display style data of the to-be-displayed three-dimensional geological feature, the segmented area being an area between the field of view distal line and the field of view division line.

4. The method according to claim 3, wherein the displaying the to-be-displayed three-dimensional geological feature in the to-be-displayed area based on a segmented area, the same shared three-dimensional model, and the display style data of the to-be-displayed three-dimensional geological feature comprises:
displaying, in the to-be-displayed area, a to-be-displayed three-dimensional geological feature in a remaining area based on the same shared three-dimensional model and display style data of the to-be-displayed three-dimensional geological feature in the remaining area, the remaining area being an area other than the segmented area in the to-be-displayed area; or
displaying a to-be-displayed three-dimensional geological feature in a remaining area and a to-be-displayed three-dimensional geological feature of a second ratio in the segmented area in the to-be-displayed area based on the same shared three-dimensional model, display style data of the to-be-displayed three-dimensional geological feature in the remaining area, and display style data of the to-be-displayed three-dimensional geological feature of the second ratio in the segmented area.

5. The method according to claim 3, wherein the displaying the to-be-displayed three-dimensional geological feature in the to-be-displayed area based on the segmented area, the same shared three-dimensional model, and the display style data of the to-be-displayed three-dimensional geological feature comprises:
obtaining a coverage model in response to a quantity of to-be-displayed three-dimensional geological features in the segmented area being greater than a preset quantity, the coverage model being configured for covering the to-be-displayed three-dimensional geological feature in the segmented area; and
displaying the coverage model in the segmented area, and displaying, in a remaining area, a to-be-displayed three-dimensional geological feature in the remaining area based on the same shared three-dimensional model and display style data of the to-be-displayed three-dimensional geological feature in the remaining area, the remaining area being an area other than the segmented area in the to-be-displayed area.

6. The method according to claim 1, wherein the determining the plurality of three-dimensional geological features comprised in the to-be-displayed area comprises:
clustering, in response to the plurality of three-dimensional geological features comprised in the to-be-displayed area existing, the three-dimensional geological features comprised in the to-be-displayed area, and determining the plurality of three-dimensional geological features corresponding to the same shared three-dimensional model.

7. The method according to claim 1, wherein the same shared three-dimensional model comprises shadow data and model data, the shadow data is configured to generate a shadow of the three-dimensional geological feature, and the model data is configured to generate a three-dimensional model of the three-dimensional geological feature; and
the displaying the to-be-displayed three-dimensional geological feature of the plurality of three-dimensional geological features in the to-be-displayed area based on the same shared three-dimensional model and the display style data of the plurality of three-dimensional geological features comprises:
performing depth detection on each to-be-displayed three-dimensional geological feature in the to-be-displayed area, and rendering a shadow of the to-be-displayed three-dimensional geological feature based on a depth detection result, shadow data, and display style data of the to-be-displayed three-dimensional geological feature; and
displaying, based on the model data and the display style data of the to-be-displayed three-dimensional geological feature, the to-be-displayed three-dimensional geological feature in the to-be-displayed area after rendering the shadow.

8. The method according to claim 1, wherein the electronic map is periodically refreshed, and a display size of the to-be-displayed three-dimensional geological feature is positively correlated with interface display time of the electronic map.

9. The method according to claim 8, wherein the displaying the to-be-displayed three-dimensional geological feature of the plurality of three-dimensional geological features in the to-be-displayed area based on the same shared three-dimensional model and the display style data of the plurality of three-dimensional geological features comprises:
updating display style data of the to-be-displayed three-dimensional geological feature in response to refreshing the electronic map, a display size in the updated display style data being greater than a display size in the display style data before updating; and
displaying the to-be-displayed three-dimensional geological feature in the to-be-displayed area based on the updated display style data of the to-be-displayed three-dimensional geological feature and the same shared three-dimensional model.

10. The method according to claim 1, wherein the displaying the to-be-displayed three-dimensional geological feature of the plurality of three-dimensional geological features in the to-be-displayed area based on the same shared three-dimensional model and the display style data of the plurality of three-dimensional geological features comprises:
determining a scene type corresponding to the to-be-displayed area based on scene prompt information, the scene prompt information comprising at least one of current weather information and current time information;
obtaining a decoration model matching the scene type, the decoration model being configured for decorating the same shared three-dimensional model; and
displaying the to-be-displayed three-dimensional geological feature of the plurality of three-dimensional geological features in the to-be-displayed area based on the decoration model, the same shared three-dimensional model, and the display style data of the plurality of three-dimensional geological features.

11. The method according to claim 1, wherein the obtaining the same shared three-dimensional model comprises:
determining a scene type corresponding to the to-be-displayed area based on scene prompt information, the scene prompt information comprising at least one of current weather information and current time information; and
obtaining the same shared three-dimensional model based on the scene type, a texture of the same shared three-dimensional model matching at least one of weather information and time information corresponding to the scene type.

12. The method according to claim 1, wherein the obtaining the same shared three-dimensional model and display style data of the plurality of three-dimensional geological features comprises:
obtaining, based on a model identifier of the same shared three-dimensional model, target model information corresponding to the model identifier from a style manager, and parsing the target model information, to obtain the same shared three-dimensional model, the style manager having a plurality of model identifiers and model information respectively corresponding to the plurality of model identifiers stored therein, and the model identifier being obtained based on a map tile corresponding to the to-be-displayed area; and
performing matrix transformation on display position information, display angle information, and display size information respectively based on a position transformation matrix corresponding to a coordinate system of the electronic map, to obtain a display position matrix, a display angle matrix, and a display size matrix, and using a product of the display position matrix, the display angle matrix, and the display size matrix as the display style data, wherein the display position information, the display angle information, and the display size information are obtained based on the map tile corresponding to the to-be-displayed area.

13. An apparatus comprising:
a memory storing a plurality of instructions; and
a processor configured to execute the plurality of instructions, wherein upon execution of the plurality of instructions, the processor is configured to:
determine, in response to a display instruction for a to-be-displayed area in an electronic map, a plurality of three-dimensional geological features comprised in the to-be-displayed area, the plurality of three-dimensional geological features corresponding to a same shared three-dimensional model;
obtain the same shared three-dimensional model and display style data of the plurality of three-dimensional geological features, the display style data configured to indicate a display position, a display angle, and a display size of the three-dimensional geological features in the to-be-displayed area; and
display, via a display, the to-be-displayed area on the electronic map, and display, via the display, a to-be-displayed three-dimensional geological feature of the plurality of three-dimensional geological features in the to-be-displayed area based on the shared three-dimensional model and the display style data of the plurality of three-dimensional geological features.

14. The apparatus according to claim 13, wherein in order to display, via the display, the to-be-displayed three-dimensional geological feature of the plurality of three-dimensional geological features based on the same shared three-dimensional model and the display style data of the plurality of three-dimensional geological features, the processor, upon execution of the plurality of instructions, is configured to:
determine a part of the plurality of three-dimensional geological features as the to-be-displayed three-dimensional geological feature, and obtain display style data of the to-be-displayed three-dimensional geological feature from the display style data of the plurality of three-dimensional geological features; and
display, via the display, the to-be-displayed three-dimensional geological feature based on the same shared three-dimensional model and the display style data of the to-be-displayed three-dimensional geological feature.

15. The apparatus according to claim 13, wherein in order to determine the plurality of three-dimensional geological features comprised in the to-be-displayed area, the processor, upon execution of the plurality of instructions, is configured to:
cluster, in response to the plurality of three-dimensional geological features comprised in the to-be-displayed area existing, the three-dimensional geological features comprised in the to-be-displayed area, and determine the plurality of three-dimensional geological features corresponding to the same shared three-dimensional model.

16. The apparatus according to claim 13, wherein the same shared three-dimensional model comprises shadow data and model data, the shadow data is configured to generate a shadow of the three-dimensional geological feature, and the model data is configured to generate a three-dimensional model of the three-dimensional geological feature, and
in order to display, via the display, the to-be-displayed three-dimensional geological feature of the plurality of three-dimensional geological features in the to-be-displayed area based on the same shared three-dimensional model and the display style data of the plurality of three-dimensional geological features, the processor, upon execution of the plurality of instructions, is configured to:
perform depth detection on each to-be-displayed three-dimensional geological feature in the to-be-displayed area, and render a shadow of the to-be-displayed three-dimensional geological feature based on a depth detection result, shadow data, and display style data of the to-be-displayed three-dimensional geological feature; and
display, via the display, based on the model data and the display style data of the to-be-displayed three-dimensional geological feature, the to-be-displayed three-dimensional geological feature in the to-be-displayed area after rendering the shadow.

17. A non-transitory computer-readable storage medium storing a plurality of instructions executable by a processor, wherein when executed by the processor, the plurality of instructions is configured to cause the processor to:
determine, in response to a display instruction for a to-be-displayed area in an electronic map, a plurality of three-dimensional geological features comprised in the to-be-displayed area, the plurality of three-dimensional geological features corresponding to a same shared three-dimensional model;
obtain the same shared three-dimensional model and display style data of the plurality of three-dimensional geological features, the display style data configured to indicate a display position, a display angle, and a display size of the three-dimensional geological features in the to-be-displayed area; and
display, via a display, the to-be-displayed area on the electronic map, and display, via the display, a to-be-displayed three-dimensional geological feature of the plurality of three-dimensional geological features in the to-be-displayed area based on the shared three-dimensional model and the display style data of the plurality of three-dimensional geological features.

18. The non-transitory computer-readable storage medium according to claim 17, wherein the electronic map is configured to be periodically refreshed, and a display size of the to-be-displayed three-dimensional geological feature is positively correlated with interface display time of the electronic map.

19. The non-transitory computer-readable storage medium according to claim 17, wherein in order to cause the processor to display the to-be-displayed three-dimensional geological feature of the plurality of three-dimensional geological features in the to-be-displayed area based on the same shared three-dimensional model and the display style data of the plurality of three-dimensional geological features, the plurality of instructions, when executed by the processor, is configured to cause the processor to:
determine a scene type corresponding to the to-be-displayed area based on scene prompt information, the scene prompt information comprising at least one of current weather information and current time information;
obtain a decoration model matching the scene type, the decoration model configured to decorate the same shared three-dimensional model; and
display, via the display, the to-be-displayed three-dimensional geological feature of the plurality of three-dimensional geological features in the to-be-displayed area based on the decoration model, the same shared three-dimensional model, and the display style data of the plurality of three-dimensional geological features.

20. The non-transitory computer-readable storage medium according to claim 17, wherein in order to cause the processor to obtain the same shared three-dimensional model, the plurality of instructions, when executed by the processor, is configured to cause the processor to:
determine a scene type corresponding to the to-be-displayed area based on scene prompt information, the scene prompt information comprising at least one of current weather information and current time information; and
obtain the same shared three-dimensional model based on the scene type, a texture of the same shared three-dimensional model matching at least one of weather information and time information corresponding to the scene type.
